(19) United States
(12) Patent Application Publication
(10) Pub. No.: US 2006/0138118 A1
(43) Pub. Date: Jun. 29, 2006

(54) Food processing apparatus

(76) Inventor: Wing Kin Chan, Hong Kong,SAR (CN)

Correspondence Address: BUCHANAN INGERSOLL PC;(INCLUDING BURNS, DOANE, SWECKER & MATHIS), POST OFFICE BOX 1404, ALEXANDRIA, VA, 22313-1404, US

(21) Appl. No.: 10/525,073

(22) PCT Filed: Jun. 24, 2003
(86) PCT No.: PCT/IB03/02433

§ 371 Date: Nov. 10, 2005

(30) Foreign Application Priority Data
Jun. 25, 2002 (CN) 02104726.1

(51) Int. Cl. A21B 1/22

(52) U.S. Cl. 219/400

(57) ABSTRACT

A food processing apparatus with electrical heating means as well as smoke curing capability so that food products can be smoke-cured and cooked simultaneously. The food processing apparatus is provided with means to circulate the food curing substances (the flavouring smoke) within an enclosed food processing compartment. An exhaust air passageway provided with a controllable valve and connected with particle absorption and deodorizing means to purify the exhaust air when the food curing smoke is removed from the enclosed food processing compartment is also included to alleviate or eliminate air contamination in the vicinity of the food processing apparatus.

### FIELD OF INVENTION

The present invention relates to food processing apparatus and, more particularly, to food processing apparatus with heating means as well as food curing means. More specifically, of course not solely limited thereto, the present invention relates to an electric oven with means for smoke-curing a food product.

### BACKGROUND OF THE INVENTION

Food products are frequently smoke treated or smoke cured for additional or more complicated flavours. Conventionally, food products are usually smoke cured or treated in specialized kitchens, factories or shops because specialized equipment or facilities which are usually expensive and bulky are required. Also, smoke-curing of food products by conventional ways usually require a continuous and prolonged supply of flavouring smokes. As such flavouring smokes usually have a strong smell, smoke treating or curing of food products domestically or in non-industrial environment has not been particularly popular. On the other hand, home treated or cured food products usually mean lower costs and the added flavour can be adjusted according to personal preferences.

Hence, it will be highly desirable if food processing apparatus with means for smoke treating or curing food products can be made available for domestic use or for smaller scale applications. In providing such apparatus, it will be appreciated that one of the major hurdles is probably the continuous supply of food-curing smoke. Another hurdle that has to be overcome includes the problems associated with the discharge of strongly-smelled smoke in domestic or city environment. In this regard, it will be appreciated that a good smell for one person may be a nuisance or a source of allergy to others. Therefore, a controlled, reduced or considered discharge of strongly smelled smokes will be an important factor if food processing apparatus with smoke treating or curing capabilities are to become widely used.

Furthermore, conventional ways of food curing by smoking always take a long time, for example, a few days. This means that the food products are usually dried after the smoking process and this is not always desirable.

Hence, it will be highly desirable if food processing devices or apparatus with means for smoke curing or smoke treating food products in a small scale or domestic environment while alleviating or overcoming the above known shortcomings or problems are provided.

Specifically, it will be highly desirable if such food processing devices or apparatus do not emit or discharge strong-smelled food curing smokes in an unacceptable or uncontrolled manner during or after the food curing process. Furthermore, it will be highly desirable if such food processing devices or apparatus can have the added benefit of introducing flavour to the food products by flavouring smokes as well as other appropriate food curing substances during the cooking process.

### SUMMARY OF THE INVENTION

According to the present invention, there is provided a food processing apparatus, such as an oven, including a main housing with a food processing compartment, electrical heating means, food curing substances circulation means and food curing substances removal means, said food curing substances circulation means includes food curing substances dispensing means for dispensing food curing substances into said food processing compartment and air circulation means for circulating said food curing substances inside said food processing compartment, said food curing substances removal means includes means to remove said food curing substances from said food processing compartment.

To alleviate pollution to the environment, said food substances removal means includes absorption means for absorpting said food curing substances at the downstream outlet of said food substances removal means.

Preferably, said absorption means includes a deodorizing filter.

Preferably, said main housing further includes a confined channel with an air inlet and an air outlet, said confined channel being in communication with an air moving device, said air moving device being disposed to move said curing substances from said air inlet to said air outlet through said confined air channel and for subsequent circulation in said food processing compartment.

Preferably, said food curing substances removal means includes an air channel in communication with said air moving device.

Preferably, a flow control means is provided to selectively connect said air moving device to be in communication with said air channel of said food curing substances removal means or said air channel of said air moving means which forms a part of the circulating path of said food curing substances within said food processing compartment.

Preferably, said flow control means includes a two-way valves.

Preferably, said food processing apparatus further including flow control means to selectively and alternatively activate said food curing circulation means or said food curing substances removal means.

### BRIEF DESCRIPTION OF THE DRAWINGS

A preferred embodiment of food processing apparatus of the present invention will be explained in further detail by way of example and with reference to the accompanying drawings, in which:—

FIG. 1 is a front view of a preferred embodiment of the food processing apparatus of the present invention,

FIG. 2 is a schematic partial cross-sectional view of the food processing compartment of the apparatus of FIG. 1 taken along the line A-A and illustrating the relative arrangement of the curing substances dispensing means and the food curing substances extraction or removal means,

FIG. 3 is a cross-sectional view taken along the line B-B of FIG. 2 and viewed from the top of FIG. 2, and

FIG. 4 is a cross-sectional view of the apparatus taken from the right side of FIG. 3 and along the line C-C for illustrative purpose.

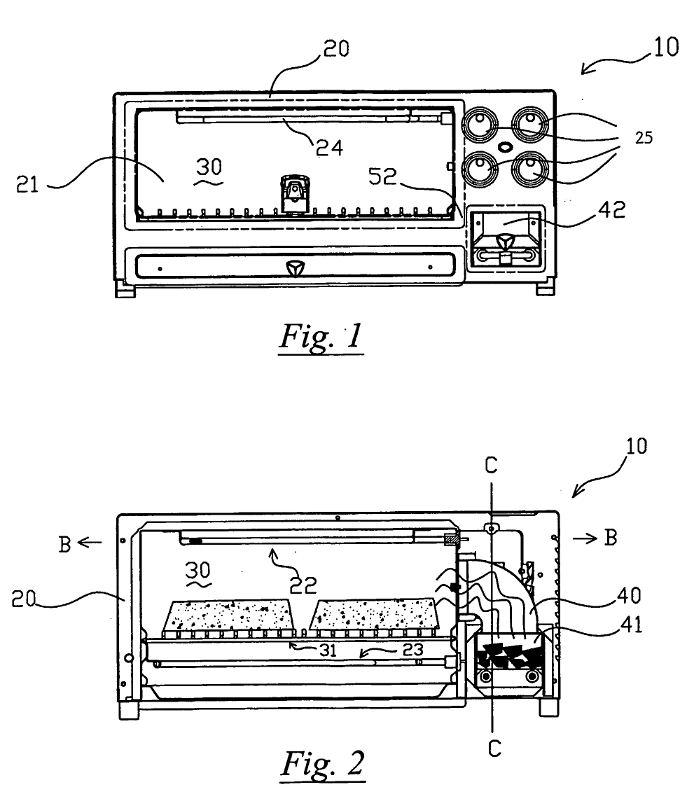

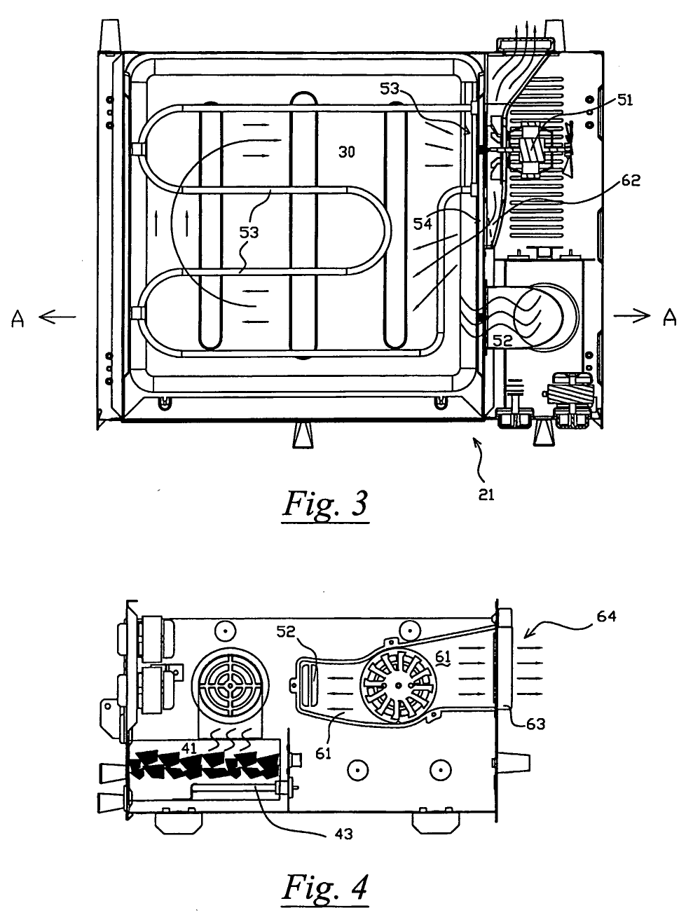

### DETAILED DESCRIPTION OF THE PREFERRED EMBODIMENT

It has been observed that if food products, for example, meats and vegetables, are smoke cured while they are being heated or cooked, flavour will be added to the cooked food in a time compatible with the typical cooking time. In many instances, it is known that if meat is cured with an appropriate smoke or other curing substances during cooking, the cooked meat will bcome more succulent and tender. In the following description, an apparatus which takes advantages of the above will be described.

Referring to the Figures, there is shown a food processing apparatus 10. The apparatus includes a main housing 20, a food processing compartment 30, food curing substances circulation means, food curing substances removal means and electrical heating means. The main housing 20 includes a metal casing which forms an enclosure surrounding the top, the bottom, the lateral sides and the back of the food processing compartment 30. The front portion 21 of the main housing includes a hinged door or window which is made of a heat resistant transparent material, such as glass. With this transparent window, a user can view through to observe or monitor the conditions of the food products being processed inside the food processing compartment and to remove the food product at an appropriate time.

The apparatus 10 includes control means for controlling the heating or power level, temperature, air circulation, fan speed, lighting and other useful features. The control means can be accessed through control knobs 25 which are provided on the front portion of the main housing 20 which is adjacent to the transparent window. This front portion includes a metal casing similar to the other parts of the main housing 20 and is coated with an insulating material to prevent accidental burning. The bottom portion of the main housing 20 is elevated above the supporting surface to provide additional thermal insulation. This additional thermal insulation helps to avoid damaging of the supporting surface due to prolonged heating or overheating of the supporting surface due to extended periods of contact with the heated compartment.

A removable shelf 31 is placed inside the compartment 30 and is supported by a pair of side racks inside the compartment 30. The shelf 31 is located intermediate the top 22 and bottom 23 portions of the food processing compartment 30 so that food products can be placed on the shelf during cooking or curing. This supporting shelf 31 is grated or perforated so that smoke or other fume-like curing substances can pass through the gratings or perforations of the supporting shelf substantially unobstructed. This will assist the curing fume, smoke or substances to move around the food processing compartment more freely. For example, the supporting shelf can be made in the form of a metal grille, a meshed wire screen, a perforated plate or other similar structures which allow substantial through passage of air. The transparent front window 21 is hinged to the main housing 20 and is sealed with sealing means around its edges to minimise or alleviate the escape of smell, odour or the curing substances from the food processing compartment 30. In general, the main housing 20 has a general design similar to the housing or casing of a conventional electrical oven commonly found in homes, offices, restaurants or other similar establishments.

A food curing substances dispensing means is placed within the main housing 30. The dispensing means includes a dispenser 40 for dispensing food curing smoke into the food processing compartment. The dispensing means is communicable with the food processing compartment 30 so that smoke or curing substances from the dispensing means can be delivered into the compartment 30. A smoke dispenser receiving compartment is formed in the main housing to receive the dispenser 40.

This dispenser receiving compartment 41 is disposed adjacent to and in communication with the food processing compartment 30. The smoke dispenser 40 can, for example, be a container carrying burning charcoal, hickory, wood or other combustible substances or medium suitable for producing food-curing smoke or flavour. Other combustible materials or substances which are suitable for food curing include, for example, wood of Oak, pecan, apple, alder, cherry, maple or mesquite. The substances are typically featured by their unique or characteristic smells or flavours when burnt. In addition, the smoke dispenser 40 may be electrically heated to cause continuous or intermittent burning of the combustible substances to provide a continuous supply of food-curing substances such as curing smoke, fume or powder, depending on the desirable type and method of food curing. For this purpose, electrical heating means 43 are provided. The smoke dispenser 40 includes a drawer with a front panel 42 and handle for easy insertion into and removal from the main housing 20.

A food curing substances circulating means is provided on the main housing to provide continuous circulation of the food curing substances within the food processing compartment for optimal food curing. This circulating means is provided to impart even distribution or dispensing of the curing substances. This circulating means provides repeated circulation of the food curing substances inside the food processing compartment. With the circulation of the food curing substances within the food processing compartment, the smoke or the other food curing substances emanating from the food curing substances dispenser can be efficiently utilized to maximize the curing effect. The food curing substances circulating means includes an air moving or circulating device 51 such as a propeller fan which causes forced movement of air within the food processing compartment 30.

To enhance even circulation of the food curing substances within the food processing compartment 30, the air moving device 51 is coupled to a confined channel 52, such as a conduit or a trough enclosed in the main housing. The inlet 53 and outlet 54 of the air channel are preferably separated by a distance comparable to the internal dimension of the food processing compartment for maximum spread of distribution of the food curing substances. For example, the inlet 53 and outlet 54 of the air channel are disposed near the top 22 and bottom 23 ends of the food processing compartment so that the food curing substances would have to travel substantially across the whole food processing compartment 30 before moving from the air channel inlet 53 to the air channel outlet 54. Of course, additional air moving devices or channel outlets can be distributed within the food processing compartment to further improve the circulation and distribution of the food curing substances within the food processing compartment 30.

Electrical heating means 24 with variable and controllable power levels are also installed on the main housing for heating the food products during the curing process. The electrical heating means and the food curing substances circulating means can be separately controlled for more flexible operation and utilization.

In order that the food curing substances can be removed from the apparatus without adversely leaving or escaping through the front window 21 when it is opened to remove the cured or cooked food products, an air exhaust passageway 61 connecting the food processing compartment to the outside is provided in the present preferred embodiment. This air exhaust passageway can be an enclosed channel or a conduit connecting the inner side of the main housing, which is in communication with the food processing compartment 30, and the outside of the main housing 20. A further duct or conduit can be provided to provide further extension of the air passageway to direct the used or residual food curing substances away from the food processing apparatus for appropriate or considered discharge of the used food curing substances.

An air moving device is provided in connection with the food curing substances removal means for more effective removal of the used food curing substances from the food processing compartment. The exhaust air passageway 61 is provided with a controllable valve 62 or gate which is normally closed when food products are being cured within the food processing compartment. The valve 62 will be opened when the curing or cooking process has completed and undesirable residual food curing substances are being removed from the food processing compartment 30.

In the present embodiment, a two-way valve which can alternatively close either the air channel 52 or the exhaust air passageway 61 is provided so that the exhaust air passageway 61 could be closed when the food curing substances are being circulated within the food processing compartment.

The circulation air channel 52 will be blocked when the residual food curing substances are being removed from the food processing compartment 30 through the exhaust air passageway. With this two-way valve arrangement, a single propeller fan 51 can be used as a common air moving device for both air circulation and the removal of the residual food curing substances. Of course, separate air moving devices may be used for the food curing substances circulation channel and the exhaust passageway without loss of generality.

Furthermore, in order to eliminate, or at least alleviate, the smell associated with the outgoing food curing substances, a deodorizing filter 63 with particle filtering or absorbing features is provided near the exit 64 of the exhaust air passageway. With this additional air filtering and particle absorption arrangement 63, air contamination inside and outside of the premises in which the apparatus is used can be substantially reduced. Of course, the deodorizing filter 63 and the particle absorption means or filter can be used separately or in combination. Modular filters are provided for easy maintenance and replacements. Activated carbon or charcoal is a good example of substances suitable for use in the deodorizing filter.

It will be appreciated that the above features can be incorporated into an oven without undue complication to provide an oven with the above food curing features.

While the present invention has been explained by reference to the preferred embodiments described above, it will be appreciated that the embodiments are only examples to illustrate the present invention and are not meant to be restrictive on the scope of the present invention. The scope of this invention should be determined from general principles with reference to the examples of the invention described above. In particular, variations or modifications which are obvious or trivial to persons skilled in the art, as well as improvements made on the basis of the present invention, should be considered as falling within the scope and boundary of the present invention. Furthermore, while the present invention has been explained by reference to smoke curing, it should be appreciated that the invention can apply, whether with or without modification, to other forms of food curing applications without loss of generality.

1. A food processing apparatus including a main housing with a food processing compartment, electrical heating means, food curing substances circulation means and food curing substances removal means, said food curing substances circulation means includes food curing substances dispensing means for dispensing food curing substances into said food processing compartment and air circulation means for circulating said food curing substances inside said food processing compartment, said food curing substances removal means includes means to remove said food curing substances from said food processing compartment.

2. A food processing apparatus according to claim 1, wherein said food substances removal means includes absorption means for absorpting said food curing substances at the downstream outlet of said food substances removal means.

3. A food processing apparatus according to claim 2, wherein said absorption means includes a deodorizing filter.

4. A food processing apparatus according to claim 1, said main housing further includes a confined channel with an air inlet and an air outlet, said confined channel being in communication with an air moving device, said air moving device being disposed to move said curing substances from said air inlet to said air outlet through said confined air channel and for subsequent circulation in said food processing compartment.

5. A food processing apparatus according to claim 4, wherein said food curing substances removal means includes an air channel in communication with said air moving device.

6. A food processing apparatus according to claim 5, wherein a flow control means is provided to selectively connect said air moving device to be in communication with said air channel of said food curing substances removal means or said air channel of said air moving means which forms a part of the circulating path of said food curing substances within said food processing compartment.

7. A food processing apparatus according to claim 6, wherein said flow control means includes a two-way valves.

8. A food processing apparatus according to claim 1, further including flow control means to selectively and alternatively activate said food curing circulation means or said food curing substances removal means.
